(19) United States
(12) Patent Application Publication
(10) Pub. No.: US 2026/0084460 A1
(43) Pub. Date: Mar. 26, 2026

(54) APPARATUS AND METHODS FOR DECORATING HEADWEAR

(71) Applicant: EstelleJoyLynn, LLC, Normandy Beach, NJ (US)

(72) Inventor: Robinlynn Young, Normandy Beach, NJ (US)

(21) Appl. No.: 19/207,675

(22) Filed: May 14, 2025

Related U.S. Application Data
(60) Provisional application No. 63/647,411, filed on May 14, 2024.

(51) Int. Cl. B44C 1/17; A42B 1/004

(52) U.S. Cl. CPC B44C 1/1712; A42B 1/004

(57) ABSTRACT

A device and methods of using the device that facilitate the application of designs to a brim of a hat are provided. The methods can include a method of applying a decal to a brim of a hat. A material sheet can be provided, with the material sheet including a backing material and a decal material, the decal material including a first side having a printed design and a second side including a first adhesive. A decal can be formed from the material sheet using a decal template shaped and sized to the brim of the hat extending from a dome of the hat. The decal can be applied to the brim using a heat press.

### CROSS-REFERENCE TO RELATED APPLICATION

This application claims priority to and the benefit of U.S. Provisional Ser. No. 63/647,411 , filed on May 14, 2024, which is hereby incorporated by reference herein in its entirety for all purposes.

### TECHNICAL FIELD

Aspects of the invention relate generally to the application of designs to headwear, and, more specifically, to a device and methods of using the device that facilitate the application of designs to the brim of a hat.

### BACKGROUND

Conventional hats can include a brim or a bill. Brimmed hats, and specifically baseball style hats, trucker hats, visors, and similar hats do not include aftermarket non-fabric decorations or designs on the brim or bill of the hat. Accordingly, needs exist for an improved device and method for applying decorations or designs on the brim and/or bill of the hat. Further, needs exist for the ability to apply aftermarket, non-fabric decorations or designs on the brim and/or bill of hat, for example, after the hat is initially purchased to allow for customization of the hat.

### SUMMARY

In various embodiments, the present disclosure relates to a method of applying a decal to a portion of a hat (e.g., pre-manufactured hat). In general, in one aspect, embodiments of the invention feature a method of applying a decal to a brim of a hat. The method can include providing a material sheet including a backing material and a decal material, the decal material including a first side having a printed design and a second side including a first adhesive; forming a decal from the material sheet using a decal template shaped and sized to a brim of a hat extending from a dome of the hat; and applying the decal to the brim using a heat press.

One or more of the following features may be included. The material sheet can include the backing material laminated (e.g., removably laminated) to the second side of the decal material. The backing material can include a polyester material. The decal material can include a heat transfer vinyl material. The first adhesive can be a heat-activated adhesive. The first adhesive can include a polyurethane material. In some variations, forming the decal from the material sheet using the decal template can further include: cutting the decal from the material sheet using the decal template. The method can further include, before applying the decal to the brim, removing the backing material from the decal. In some variations, applying the decal to the brim using the heat press can further include: positioning the decal on the brim, the decal being aligned with the brim; placing the hat within the heat press; and applying, by the heat press and with the decal positioned on the brim, at least one of heat or pressure to the decal. In some variations, applying at least one of heat or pressure to the decal can further include applying heat and pressure to the decal. The brim of the hat can partially surround the dome of the hat or fully surround the dome of the hat. The method can further include stitching, using an embroidery machine, on the dome of the hat.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a front perspective view of a pre-manufactured hat having a brim, in accordance with some embodiments;

FIG. 2 is a front perspective view of a decal template, in accordance with some embodiments;

FIG. 3 shows a decal material having a printed design, in accordance with some embodiments;

FIG. 4 shows a decal template used with a decal material, in accordance with some embodiments;

FIG. 5 shows a decal being removed from a backing material, in accordance with some embodiments;

FIG. 6 shows a decal being placed onto a brim of a hat, in accordance with some embodiments;

FIG. 7A shows a hat including a decal positioned within a heat press, in accordance with some embodiments;

FIG. 7B shows a hat including a decal the decal positioned within a heat press, in accordance with some embodiments;

FIG. 7C shows a hat including a decal the decal positioned within a heat press, in accordance with some embodiments;

FIG. 7D shows a hat including a decal the decal positioned within a heat press, in accordance with some embodiments;

FIG. 8 shows a hat after heat pressing and having a decal applied to a top of a brim of the hat, in accordance with some embodiments;

FIG. 9 shows a hat after heat pressing and having a decal applied to an underside of a brim of the hat, in accordance with some embodiments;

FIG. 10A shows a concave heat press including a convex press portion and a concave press portion, in accordance with some embodiments;

FIG. 10B shows the convex press portion of FIG. 10A and a brim of a hat, in accordance with some embodiments;

FIG. 11 shows a hat having a decal applied to a front panel of the hat, in accordance with some embodiments;

FIG. 12 shows a hat having a decal placed onto a front panel of the hat before application, in accordance with some embodiments;

FIG. 13 shows a hat having a decal stitched onto a front panel of the hat before application is shown, in accordance with some embodiments;

FIG. 14 shows a hat positioned within a heat press and having a decal stitched onto a front panel of the hat, in accordance with some embodiments; and

FIG. 15 is a flowchart of a method of applying a decal to a brim of a hat, in accordance with some embodiments.

### DETAILED DESCRIPTION

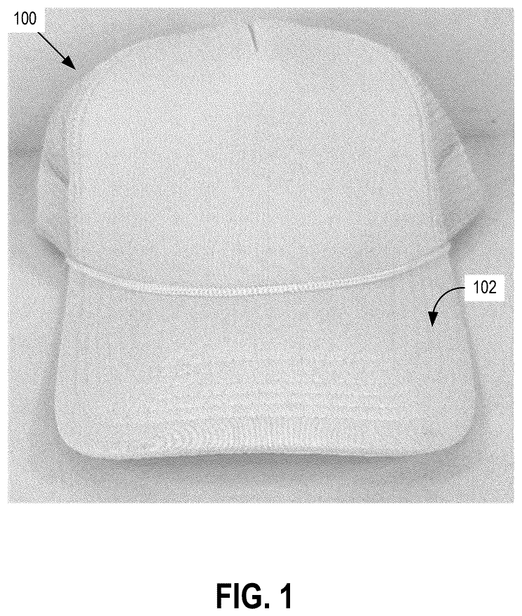

As described herein, brimmed hats, and specifically baseball style hats, trucker hats, visors, and similar hats do not include aftermarket non-fabric decorations or designs on the brim or bill of the hat. Accordingly, embodiments of the present disclosure are directed to a method and tooling for adding an aftermarket decal/design to the brim of a pre-manufactured hat as shown in FIG. 1 below. In some embodiments, a decal applied using the techniques described herein may be shaped and sized to be applied to any suitable brim or bill of a hat that extends from a dome of the hat. The decal may be shaped and sized to be applied to a brim that (i) extends from one or more portions of a dome of a hat and/or (ii) extends from and (e.g., partially or completely) surrounds a dome of a hat. Accordingly, the decal may be shaped and sized for application to baseball style hats, trucker hats, visors, and similar hats, as well as full and/or wide brim hats such as bucket hats, boonie hats, sun hats, fedoras, panama hats, boater hats, gambler hats, cowboy hats, outback hats, and safari hats. Accordingly, a template for a brim or bill of a hat may be shaped and sized to match the shape and size of the brim or portion thereof to which the decal is to be applied.

Referring to FIG. 1, a front perspective view of a pre-manufactured hat 100 having a brim 102 is shown. Conventional clothing applique processes and materials are not suitable for adding an aftermarket decal/design to the brim 102 of a pre-manufactured hat 100 for numerous reasons. For example, existing cloth decal transfer papers (e.g., such as those used for shirts) do not produce a crisp, transparent image and are difficult to align to the brim of the hat. Further, this material does not give or stretch in two dimensions to allow for accurate placement on the brim of the hat, such that it does not lay flat on the dome of the brim/bill of the hat.

To address these challenges, a two-sided material can be used as a decal material for a decal that can be applied to the brim and/or bill of a hat. The decal material can have a first side having a polyurethane heat-activated adhesive, with the other, second side being printable using conventional printing techniques. One example of such a two-sided material for the decal is a heat transfer vinyl material, which is a special polyurethane with a heat-activated adhesive (e.g., typically polyester-based adhesive) that can be used on certain fabrics and materials to apply designs to promotional products, textiles and apparel, such as T-shirts. The heat transfer vinyl material can be manufactured and provided with a removable backing material, such as a clear polyester carrier, that together form a material sheet from which a decal can be cut. The heat transfer vinyl can be laminated together with the clear polyester carrier in a roll or sheet form, with the heat transfer vinyl having an adhesive tacky backing on a side coupling the vinyl to the clear polyester carrier. Accordingly, the material sheet including the laminated heat transfer vinyl can be cut and placed on a substrate (e.g., such as a portion of hat) for application via a heat press, with the heat transfer vinyl being separable from the polyester carrier when the heat transfer vinyl material is to be applied to a bill or brim of a hat.

In some embodiments, the decal material is initially translucent, allowing light to pass through the material. Upon heating, the decal material becomes transparent, thus allowing the color of the fabric to which the decal is being applied to show through the decal. Importantly, the decal material can have enough stretch to allow for easy manipulation and accurate and smooth (e.g., without wrinkles or bubbles) placement onto the brim or bill of a hat. In some instances, the decal material can be water resistant and/or washable. Once the decal material is applied (e.g., heat pressed) onto the brim or bill of the hat, the polyurethane, heat-activated adhesive permanently melts into and adheres to the fabric covering the brim or bill. Accordingly, no peeling of the decal occurs or is necessary once the decal material is applied onto the brim or bill.

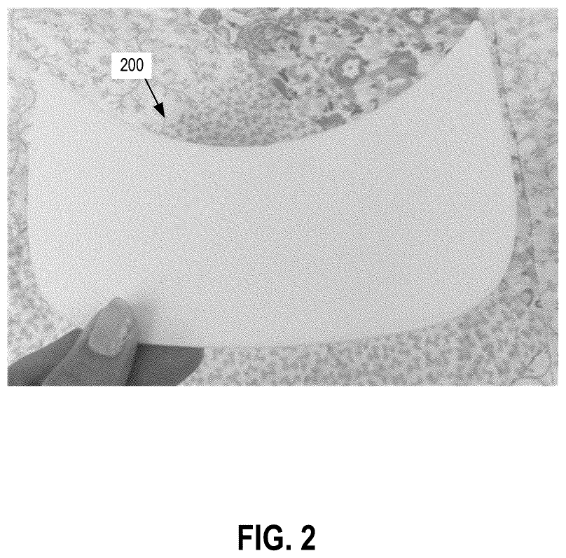

In some instances, an insert (e.g., plastic insert) having a shape of a conventional hat brim may be used as a decal template to cut the adhesive decal to size. Referring to FIG. 2, a front perspective view of a decal template 200 is shown. While the decal template 200 shown in FIG. 2 illustrates a baseball-style hat brim, the same technique for producing a decal template 200 may be used for any style of hat that includes an insert that shapes and/or defines the brim. In one example, the template 200 is approximately 7 inches wide, 3 inches deep at the middle of the brim, and 4 inches deep at each end. In some cases, a decal template may have a shape and/or size as disclosed in U.S. Design Ser. No. 29/953,187 , filed on Jul. 19, 2024, which is hereby incorporated by reference herein in its entirety for all purposes.

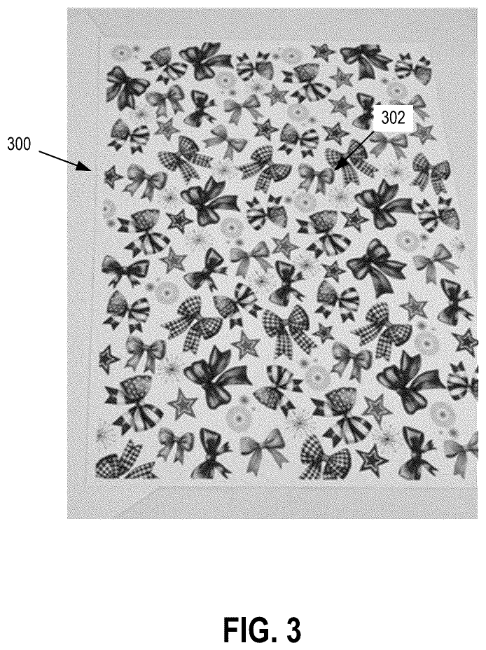

Referring to FIG. 3, a decal material 300 laminated on a backing material and having a printed design 302 is shown. Any desired custom pattern, image, and/or design may be printed onto the decal material 300 using conventional printing techniques before or after the decal material is cut to size (e.g., using the decal template). As an example, the decal material 300 can have a design 302 printed using conventional techniques before the decal material 300 is cut to form the decal having a desired size of the brim or bill to which the decal is to be applied.

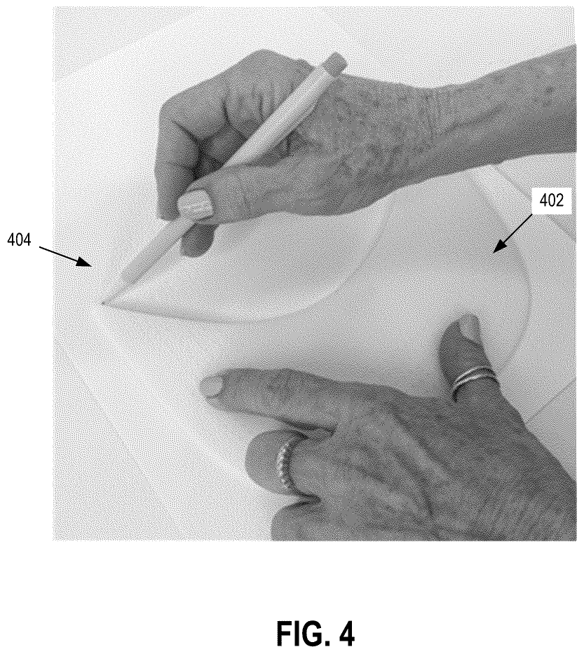

Referring to FIG. 4, a decal template 402 being used to cut a decal material 404 and backing material to a desired shape and size is shown. The decal material 404, such as a printed polyurethane heat-activated adhesive material, with the backing material may be placed adjacent to (e.g., over or under) the decal template 402, with the template used to cut the desired shape for the decal from the decal material, such as the shape for the brim of a hat. The template can be used to cut the decal material before or after a design is printed onto a side of the decal material. The decal can be cut to shape from the decal material as one contiguous shape using any suitable cutting technique.

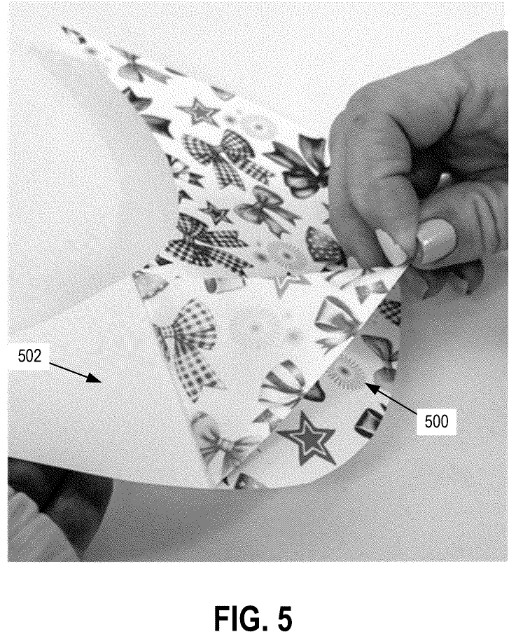

In some embodiments, the same process for cutting a decal using a decal material and a decal template may be used to create decal templates and appliques for other parts of the hat (e.g., a dome of the hat or a portion thereof), as well as other hats of different shapes and sizes. In some cases, the same process for cutting a decal using a decal material and a decal template may be used to create decal templates and appliques for other parts apparel with different shapes and sizes. Referring to FIG. 5, a decal 500 being removed from a backing material 502 is shown. Once the properly shaped decal 500 is cut to the desired size (e.g., using a decal template), the backing material 502 can be removed from the decal 500. After the decal 500 is removed from the backing material 502, the remaining decal 500 can be formed from only the decal material as described herein.

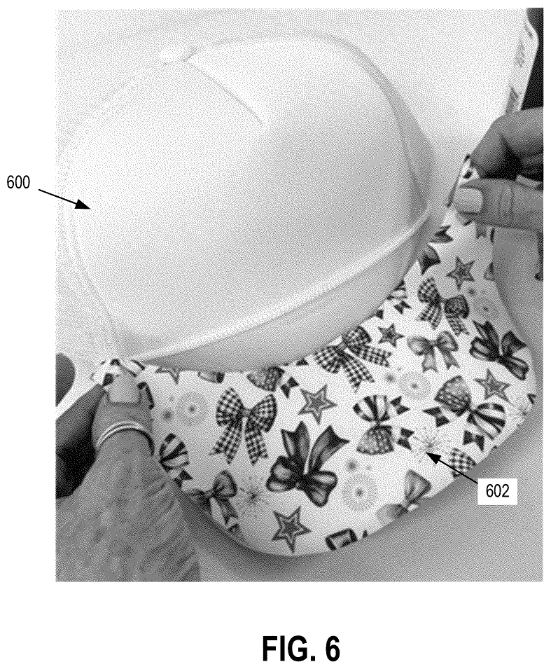

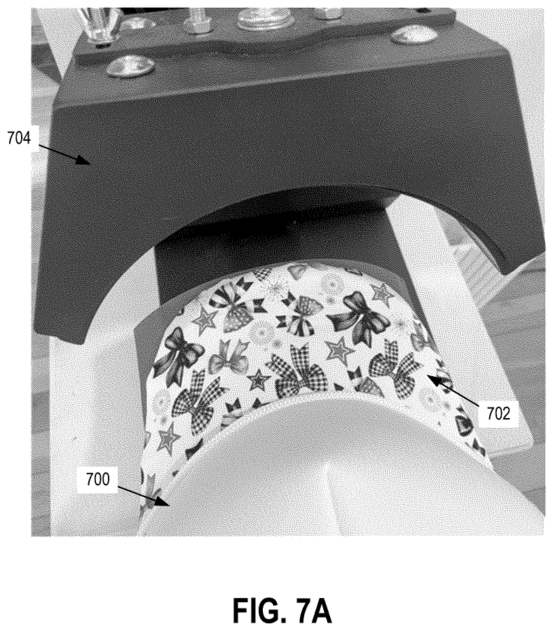

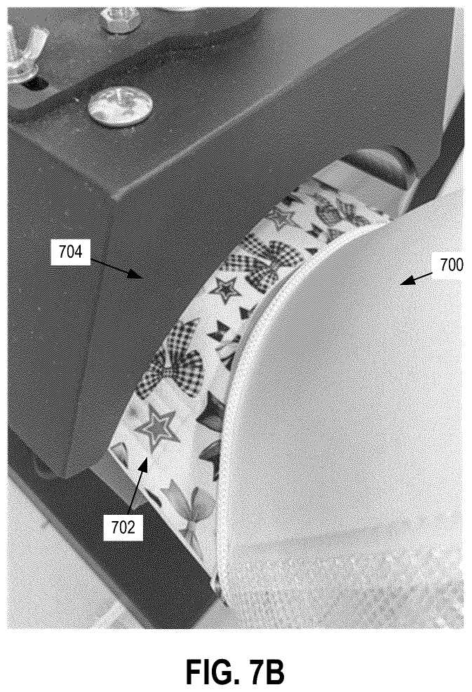

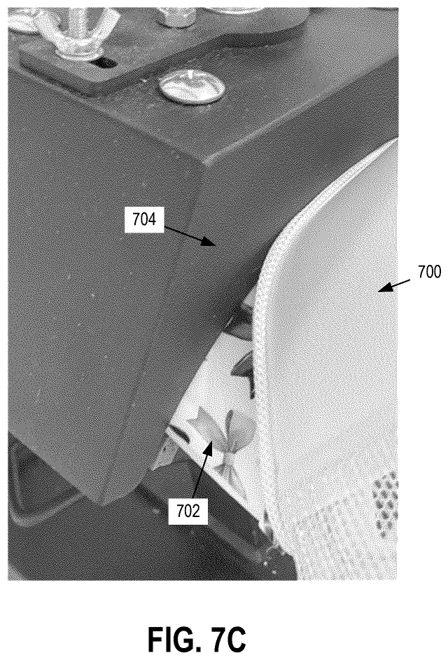

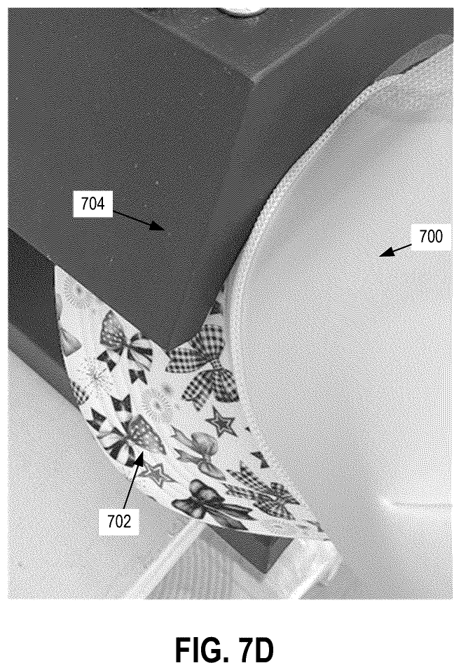

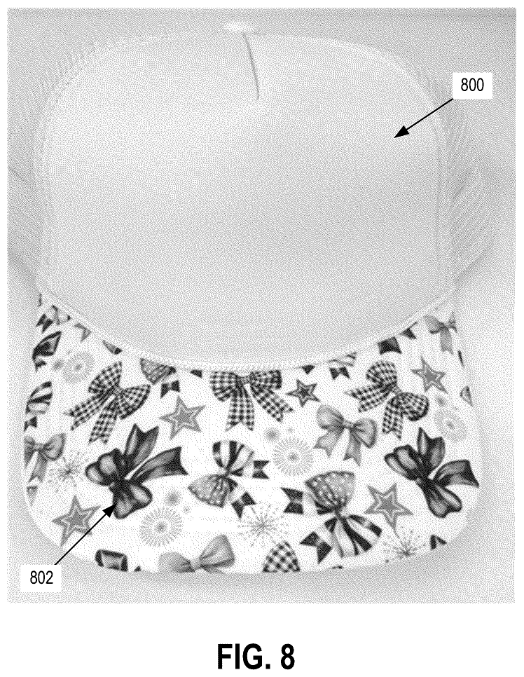

Referring to FIG. 6, a decal 602 being placed onto a brim of a hat 600 is shown. Once the shaped decal is properly aligned onto the brim/bill of the hat, a hat heat press can be applied to the brim/bill to activate the adhesive backing of the decal and/or melt the decal into the brim/bill to permanently adhere the decal to the hat. Referring to FIGS. 7A, 7B, 7C, and 7D, a hat 700 including a decal 702, with the decal 702 positioned within a heat press 704 is shown. In one particular application, the heat press 704 can be applied to the decal 702 on the brim of the hat 700 for 20 seconds at 325 degrees Fahrenheit (°F.), although heat hat presses may differ so different temperatures and timing may be necessary. As an example, the heat press 704 can be applied to the decal 702 on the brim of the hat 700 for a range of 1 to 60 seconds at a constant or variable temperate in a range of 200° F. to 450° F. In some variations, applying the heat press to the decal on the hat can include causing application, by the heat press, of heat and/or pressure (e.g., by contact) to the decal, thereby causing the heat-activated adhesive of the decal to permanently melt into and adhere to the fabric covering the brim of the hat. In some variations, applying the heat press to the decal on the hat can include causing application, by the heat press, of both heat and pressure to the decal. In some cases, certain heat presses, decals, and/or brims/bills may require more than one (e.g., three) different application of the heat press. As an example, a particular decal applied to a brim of a particular hat may require three separate presses within the heat press to accommodate a shape of the brim within the heat press, including pressing once in the middle of the brim, once on the right side of the brim, and once on the left side of the brim. Referring to FIG. 8, a hat 800 having a decal 802 applied to a top of a brim of the hat 800 is shown. The hat 800 is shown after application of a heat press to permanently apply the decal to the brim of the hat as described herein.

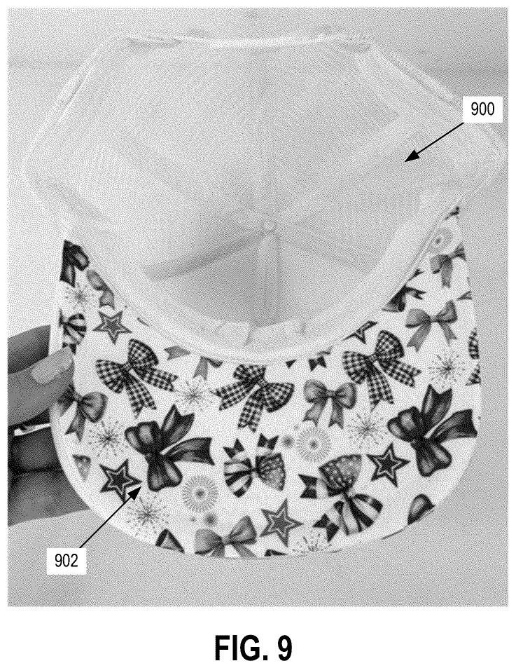

In some embodiments, a decal can be applied to other areas and/or portions of a hat using the apparatus and techniques described herein. Referring to FIG. 9, a hat 900 having a decal 902 applied to a bottom (i.e., underside) of a brim of the hat 900 is shown. The decal 902 can be applied to the bottom of the brim. The same application and heating process described herein can be performed (e.g., repeated) on the bottom (i.e., underside) of the brim to apply the decal 902 to the bottom of the brim.

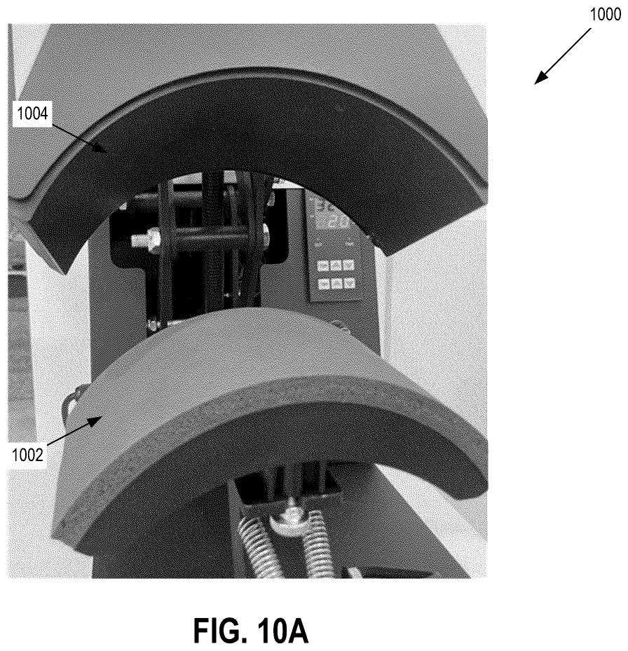

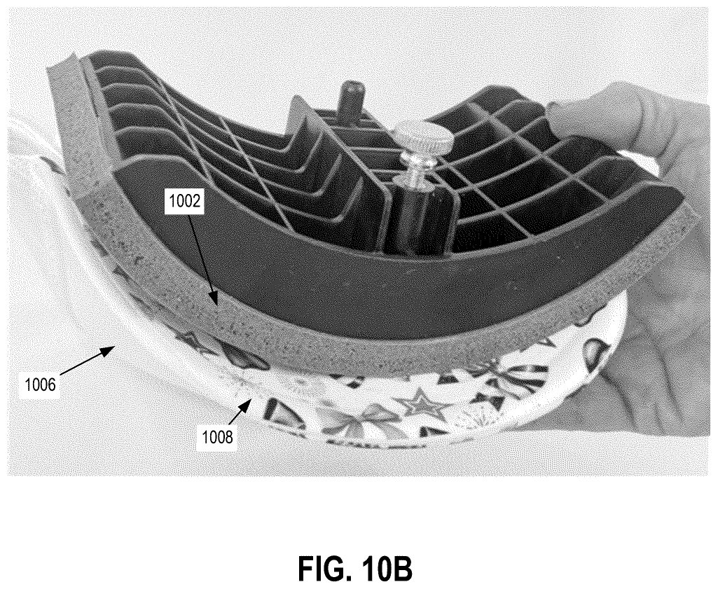

In some embodiments, a heat press used to apply heat and/or pressure to a decal can include a heat press that corresponds to (e.g., mirrors) the shape of the particular brim or bill to which the decal is to be applied. Referring to FIG. 10A, a concave heat press 1000 including a convex (e.g., crescent shaped) press portion 1002 and concave press portion 1004 is shown.

Referring to FIG. 10B, a convex press portion 1002 of the heat press 1000 pressed against a bottom of a brim 1008 of a hat 1006 is shown. The concave heat press may be used to improve efficiency of heat pressing by allowing the application to the decal to the brim of the hat using one pressing step rather than more than one heat pressing step (e.g., three heat pressing steps). Further, the concave heat press may be used to eliminate or reduce the likelihood that any of the multiple presses would cause in inconsistencies, defects, or disparities in the application of the decal to the brim. As shown in FIG. 10B, a matching convex press portion 1002 for the underside of the brim may be used in the heat press and applied to a brim 1008 of a hat 1006.

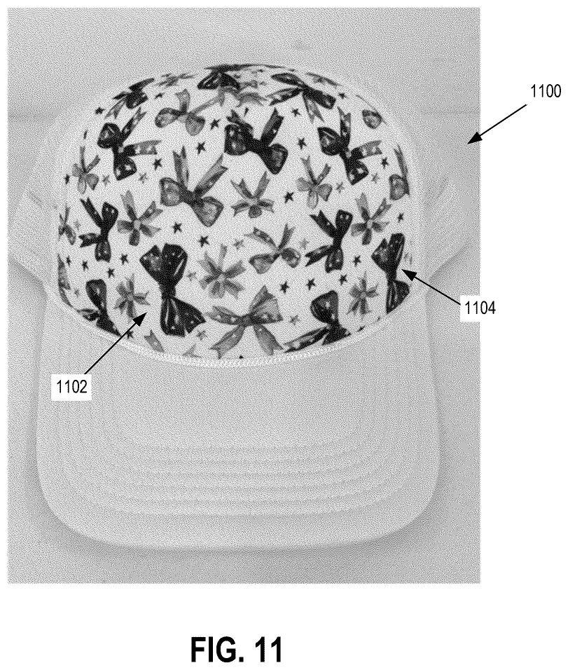

In some embodiments, in another variation of the disclosure, the techniques and apparatuses described herein may be used to form and permanently apply custom overlay designs to the front and/or top of a dome of a hat by replicating the decal application process for the front panel of the hat. As an example, the decal template could be shaped and sized to match the front panel of the hat. Referring to FIG. 11, a hat 1100 having a decal 1102 applied to a front panel 1104 of the hat 1100 is shown. The decal 1102 can be applied to the front panel 1104 using the techniques described herein for application of a decal to a brim or bill of a hat.

In some embodiments, a combination of the polyurethane heat-activated adhesive and embroidery may be used to further enhance the design of a hat having an applied decal. For this application, a custom embroidery file may be generated using conventional computerized design software. The file can define a design including images resembling stitching around the boarder to emulate a sewn on patch. The design defined by the file can be printed onto the polyurethane heat-activated adhesive material and cut to the desired size as described herein for a decal. In some instances, the material can be cut to a size that is intentionally larger than the area to be covered by the material. The backing material can be removed from the cut decal, leaving the decal with only the adhesive decal material with first, adhesive side and a second side having a printed design. The adhesive side of the decal can be placed onto the front panel of the hat.

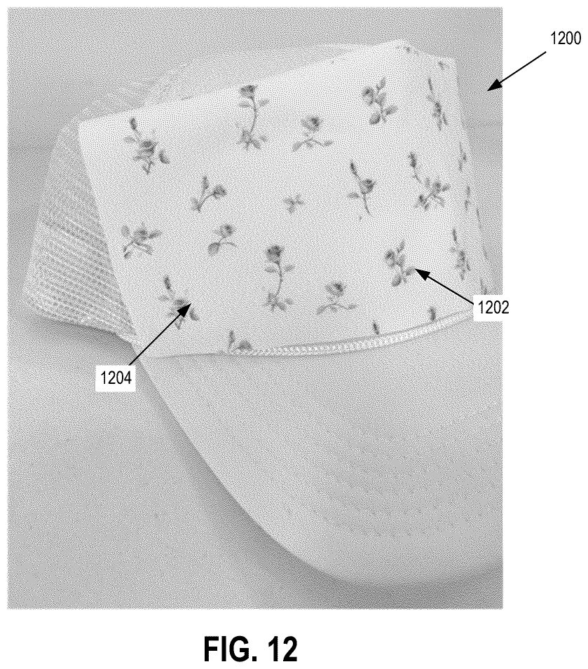

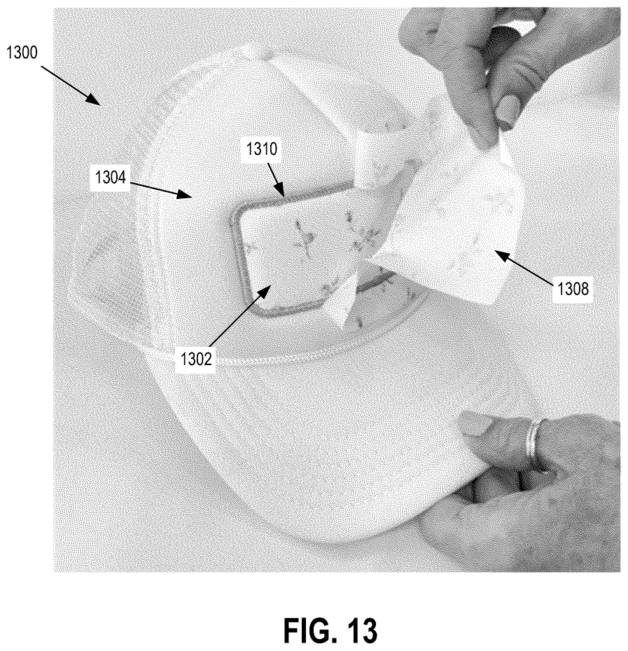

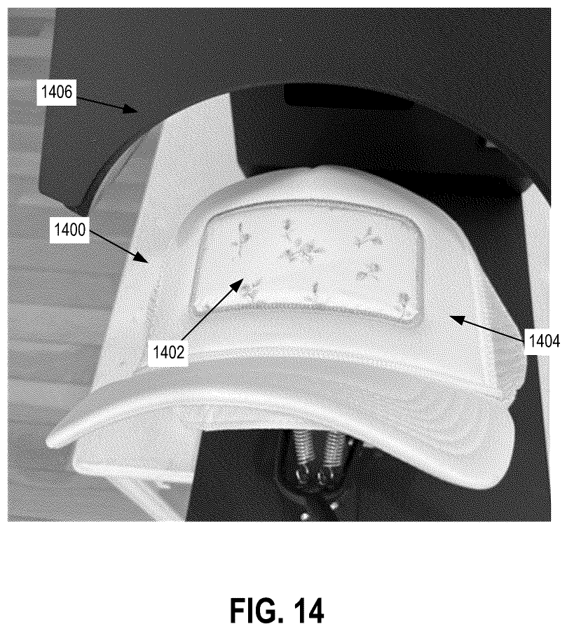

Referring to FIG. 12, a hat 1200 having a decal 1202 placed onto a front panel 1204 of the hat 1200 before application (e.g., heat pressing) is shown. After the decal is placed onto the front panel of the hat, the hat having the decal placed thereon can then be placed onto an embroidery machine. The embroidery machine can then stitch the decal to the front panel of the hat to couple the decal to the hat. Once stitching of the decal to the hat is completed, any excess material extending beyond the stitched area can be removed from around the stitched area (e.g., patch). Referring to FIG. 13, a hat 1300 having a decal 1302 stitched onto a front panel 1304 of the hat 1300 before application (e.g., heat pressing) is shown. As shown in FIG. 13, the excess material 1308 can be removed from around the stitched area 1310 of the hat 1300. After the excess material is removed from the hat, the hat can then be placed onto the heat press and the heat press can be applied to the decal described herein (e.g., with regard to the brim process) to seal the design in place. Referring to FIG. 14, a hat 1400 positioned within a heat press 1406 and having a decal 1402 stitched onto a front panel 1404 of the hat 1400 is shown. The heat press can then be applied to the decal to apply the decal to the front panel of the hat. The same technique for applying the decal to the brim and front panel of a hat may be used for any portion of the hat, such as a back panel, side panels, or a portion of a brim. After the decal is applied to the front panel of the hat, the embroidery machine can be used to stitch a design on top of the applied decal (e.g., on the dome of the hat).

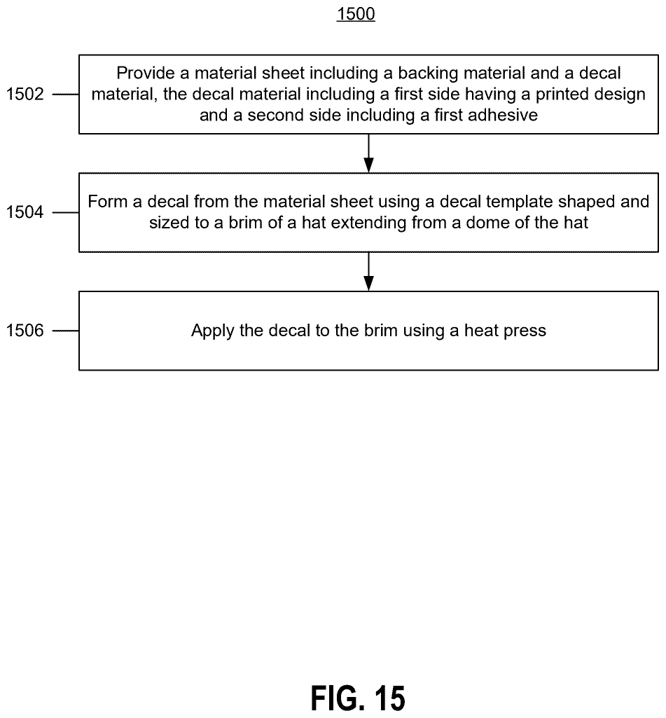

Referring to FIG. 15, a method 1500 for applying a decal to a brim of a hat can include one or more of the following steps. While the method 1500 is described with respect to applying a decal to a brim of a hat, the method 1500 may be adapted for any portion of a hat as described herein. In some cases, the method can be performed using a decal template and a heat press.

At step 1502, the method 1500 can include providing a material sheet including a backing material and a decal material, the decal material including a first side having a printed design and a second side including a first adhesive.

At step 1504, the method 1500 can include forming a decal from the material sheet using a decal template shaped and sized to a brim of a hat extending from a dome of the hat.

At step 1506, the method 1500 can include applying the decal to the brim using a heat press. Other features may be included in the method 1500 as described herein.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of. ” “Consisting essentially of,”when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of applying a decal to a brim of a hat, the method comprising:
providing a material sheet comprising a backing material and a decal material, the decal material comprising a first side having a printed design and a second side comprising a first adhesive;
forming a decal from the material sheet using a decal template shaped and sized to a brim of a hat extending from a dome of the hat; and
applying the decal to the brim using a heat press.

2. The method of claim 1, wherein the material sheet comprises the backing material laminated to the second side of the decal material.

3. The method of claim 1, wherein the backing material comprises a polyester material.

4. The method of claim 1, wherein the decal material comprises a heat transfer vinyl material.

5. The method of claim 1, wherein the first adhesive is a heat-activated adhesive.

6. The method of claim 1, wherein the first adhesive comprises a polyurethane material.

7. The method of claim 1, wherein forming the decal from the material sheet using the decal template further comprises:
cutting the decal from the material sheet using the decal template.

8. The method of claim 1, further comprising:
before applying the decal to the brim, removing the backing material from the decal.

9. The method of claim 1, wherein applying the decal to the brim using the heat press further comprises:
positioning the decal on the brim, the decal being aligned with the brim;
placing the hat within the heat press; and
applying, by the heat press and with the decal positioned on the brim, at least one of heat or pressure to the decal.

10. The method of claim 9, wherein applying at least one of heat or pressure to the decal further comprises applying heat and pressure to the decal.

11. The method of claim 1, wherein the brim of the hat partially surrounds the dome of the hat or fully surrounds the dome of the hat.

12. The method of claim 1, further comprising stitching, using an embroidery machine, on the dome of the hat.
